(19) United States
(12) Patent Application Publication
(10) Pub. No.: US 2024/0275569 A1
(43) Pub. Date: Aug. 15, 2024

(54) PHYSICAL UPLINK CHANNEL TRANSMISSIONS IN SUB-BAND FULL DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Yi Huang, San Diego, CA (US); Gokul Sridharan, Sunnyvale, CA (US); Abdelrahman Mohamed Ahmed Mohamed Ibrahim, San Diego, CA (US); Ahmed Attia Abotabl, San Diego, CA (US)

(21) Appl. No.: 18/413,926

(22) Filed: Jan. 16, 2024

Related U.S. Application Data
(60) Provisional application No. 63/485,132, filed on Feb. 15, 2023.

(51) Int. Cl. H04L 5/14; H04L 5/00; H04W 72/232

(52) U.S. Cl. CPC H04L 5/14; H04L 5/0053; H04L 5/0092; H04W 72/232

(57) ABSTRACT

Sub-band full duplexing (SBFD) may allow a user equipment (UE) to both transmit and receive in the same band using an uplink sub-band and one or more downlink sub-bands. Although SBFD may be configured on only some slots, a configuration of a physical uplink channel may be applicable to all symbols. A UE receives a configuration of a physical uplink channel. The configuration is applicable to SBFD symbols and to non-SBFD symbols. The UE receives an indication of resources for transmission on at least a slot configured with the SBFD symbols. The UE determines whether to transmit the physical uplink channel on the resources based on whether all resource blocks of the physical uplink channel are within an uplink sub-band.

### CROSS-REFERENCE TO RELATED APPLICATIONS

This application claims priority to U.S. Provisional Application No. 63/485,132 titled “PHYSICAL UPLINK CHANNEL TRANSMISSIONS IN SUB-BAND FULL DUPLEX SYMBOLS,” filed Feb. 15, 2023, which is assigned to the assignee hereof, and incorporated herein by reference in its entirety.

### BACKGROUND

### Technical Field

The present disclosure relates generally to communication systems, and more particularly, to physical uplink (UL) channel transmissions in sub-band full duplex (SBFD) symbols.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for a victim user equipment (UE) are provided. The method includes receiving a configuration of a physical uplink channel, the configuration being applicable to sub-band full duplex (SBFD) symbols and to non-SBFD symbols. The method includes receiving an indication of resources for transmission on at least a slot configured with the SBFD symbols. The method includes determining whether to transmit the physical uplink channel on the resources based on whether all resource blocks of the physical uplink channel are within an uplink sub-band.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a base station. The method includes transmitting, to a UE, a configuration of a physical uplink channel, the configuration being applicable to SBFD symbols and to non-SBFD symbols. The method includes transmitting an indication of resources for transmission on at least a slot configured with the SBFD symbols. The method includes determining whether the UE transmits the physical uplink channel on the resources based on whether all resource blocks of the physical uplink channel are within an uplink sub-band.

The present disclosure also provides an apparatus (e.g., a base station) including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system including an access network, in accordance with certain aspects of the present description.

FIG. 2A is a diagram illustrating an example of a first frame, in accordance with certain aspects of the present description.

FIG. 2B is a diagram illustrating an example of downlink (DL) channels within a subframe, in accordance with certain aspects of the present description.

FIG. 2C is a diagram illustrating an example of a second frame, in accordance with certain aspects of the present description.

FIG. 2D is a diagram illustrating an example of uplink (UL) channels within a subframe, in accordance with certain aspects of the present description.

FIG. 3 is a diagram illustrating an example of a base station and user equipment (UE) in an access network, in accordance with certain aspects of the present description.

FIG. 4 is a resource diagram illustrating available UL resources for different slot types including a slot with sub-band full duplex (SBFD) symbols, in accordance with certain aspects of the present description.

FIG. 5 is a resource diagram illustrating an example of a physical uplink control channel (PUCCH) resource set in comparison to UL resources in an example SBFD slot.

FIG. 6 is a message diagram illustrating example messages for physical UL channels using SBFD symbols.

FIG. 7 is a conceptual data flow diagram illustrating the data flow between different means/components in an example BS, in accordance with certain aspects of the present description.

FIG. 8 is a conceptual data flow diagram illustrating the data flow between different means/components in an example UE, in accordance with certain aspects of the present description.

FIG. 9 is a flowchart of an example method for a UE to transmit a physical UL channel on SBFD symbols.

FIG. 10 is a flowchart of an example method for a base station to receive a physical UL channel on SBFD symbols, in accordance with certain aspects of the present description.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Full duplex communication may allow a wireless communication device to transmit and receive at the same time. In-band full duplex (IBFD) may refer to transmission and reception on the same time and frequency resource. The uplink (UL) and the downlink (DL) may share the same IBFD time and frequency resource, which may include fully overlapping resources or partially overlapping resources. Sub-band frequency division duplexing (SBFD) may refer to transmission and reception at the same time on different frequency resources. The DL resource may be separated from the UL resource in the frequency domain by a guard gap. For example, an UL sub-band may be configured as the UL resource for SBFD. The UL sub-band may be located in the middle of a DL resource to separate the UL transmission from adjacent frequency resources. A resource element (RE) may refer to a basic unit of resources that is one sub-carrier on one symbol. REs may be grouped into resource blocks (RBs) in a symbol for scheduling. In some cases, a SBFD-capable UE may be configured for SBFD on the UL sub-band in some time-domain resources such as slots or symbols. For example, a slot may be configured as DL, UL, or SBFD. Any symbols in an SBFD slot may be considered SBFD symbols. Similarly, one or more symbols within a slot (e.g., a DL slot) may be designated as SBFD symbols. SBFD symbols may provide flexibility in scheduling a physical UL channel such as a physical uplink control channel (PUCCH) or physical uplink shared channel (PUSCH) from the SBFD-aware UE. For instance, a UE may be able to transmit in a DL slot on SBFD symbols rather than waiting for an UL slot or symbol.

The use of SBFD symbols for physical UL channels may imply additional configuration of resources specific for SBFD. For example, conventional UL configuration for PUCCH may define PUCCH resource sets including multiple PUCCH resources for a UE. The UE may be indicated with one of the configured resources for a specific PUCCH transmission within one of the PUCCH resource sets via a physical resource indication (PRI) field of a DL control information (DCI) or by RRC configuration, e.g., higher layer configuration of the PUCCH resource ID that is used to carry persistent or semi-persistent (P/SP) channel state information (CSI) or PUCCH resource ID for scheduling request (SR) and beam failure report (BFR). Similarly, a PUSCH may be configured with a configured grant or dynamically indicated with resources via a time domain resource allocation (TDRA) and frequency domain resource allocation (FDRA) in a DCI. In some cases, because the available resources (e.g., RBs) may be different in a SBFD symbol compared to an UL symbol, a conventional configuration of UL resources may not be sufficient for SBFD symbols. One approach for SBFD symbols would be to provide a second configuration of the UL channels for SBFD symbols. A second configuration, however, may increase signaling and complexity. Accordingly, there is a need for techniques to transmit physical UL channels based on a configuration of resources that is applicable to both SBFD and non-SBFD symbols.

Additionally, some transmissions may have properties that change the resources for the transmission. For example, intra-slot frequency hopping may change the frequency-domain resources for a transmission on different symbols within a slot via changing the start RB for the uplink channel. Inter-slot frequency hopping may change the frequency-domain resources for a transmission that spans one or more slot boundaries. Repetition may extend the time-domain resources for one or more repetitions of a transmission on available resources. In some cases, repetition may invoke inter-slot frequency hopping (e.g., for a PUCCH transmission). When intra-slot frequency hopping, inter-slot frequency hopping, or repetition changes the resources for a transmission, the new or additional resources may not be within the configured UL sub-band for SBFD.

In an aspect, the present disclosure provides for a user equipment (UE) to receive a single configuration for a physical UL channel that is applicable to both SBFD and non-SBFD symbols. The non-SBFD symbols may include UL symbols and flexible symbols. For example, the configuration may be PUCCH configuration that configures a PUCCH resource set including PUCCH resources. The UE may receive an indication of resources for transmission on at least a slot configured with the SBFD symbols. For example, the UE may receive a DCI that indicates a PUCCH resource or a time domain resource allocation (TDRA) and frequency domain resource allocation (FDRA) for a PUSCH. In some cases, the size of the transmission (e.g., the number of RBs) may not be within an UL sub-band, e.g. due to intra-slot or inter-slot frequency hopping of the transmission. For example, the indication may select a PUCCH resource that starts in the middle of an UL sub-band for SBFD but extends into a DL sub-band. The UE may determine whether to transmit the physical UL channel on the resources based on whether all resource blocks of the physical UL channel are within the UL sub-band.

In some implementations, the UE may drop (e.g., not transmit) the physical UL channel when any resource blocks of the physical UL channel are outside of the UL sub-band. In other implementations, the UE may attempt to adapt the resources to accommodate all resource blocks of the physical UL channel within the UL sub-band. For example, the UE may move the number of resource blocks to be within the UL sub-band or extend the number of symbols to transmit the resource blocks on only the resources that are within the UL sub-band. Additionally, when intra-slot frequency hopping, inter-slot frequency hopping, and/or repetition are configured, the UE may determine whether to apply the intra-slot frequency hopping, inter-slot frequency hopping, and/or repetition based on whether the transmission is within the UL sub-band. In some implementations, the UE may also adapt the resources and/or parameters (e.g., the start RB) for intra-slot frequency hopping, inter-slot frequency hopping, and/or repetition to transmit the physical UL channel on the UL sub-band.

Particular implementations of the subject matter described in this disclosure can be implemented to realize one or more of the following potential advantages. A configuration that is applicable to both SBFD symbols and non-SBFD symbols may provide the flexibility of SBFD with less signaling overhead and complexity than a second configuration for SBFD transmissions. The UE may transmit physical UL channels on SBFD symbols when all of the resource blocks are within the UL sub-band, or the resources can be adapted to accommodate the transmission. Additionally, intra-slot frequency hopping, inter-slot frequency hopping, and/or repetition may be implemented on both SBFD symbols and non-SBFD symbols. It enables the gNB to utilize the frequency resources within the UL-sub-band and avoid dropping of the uplink channel.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

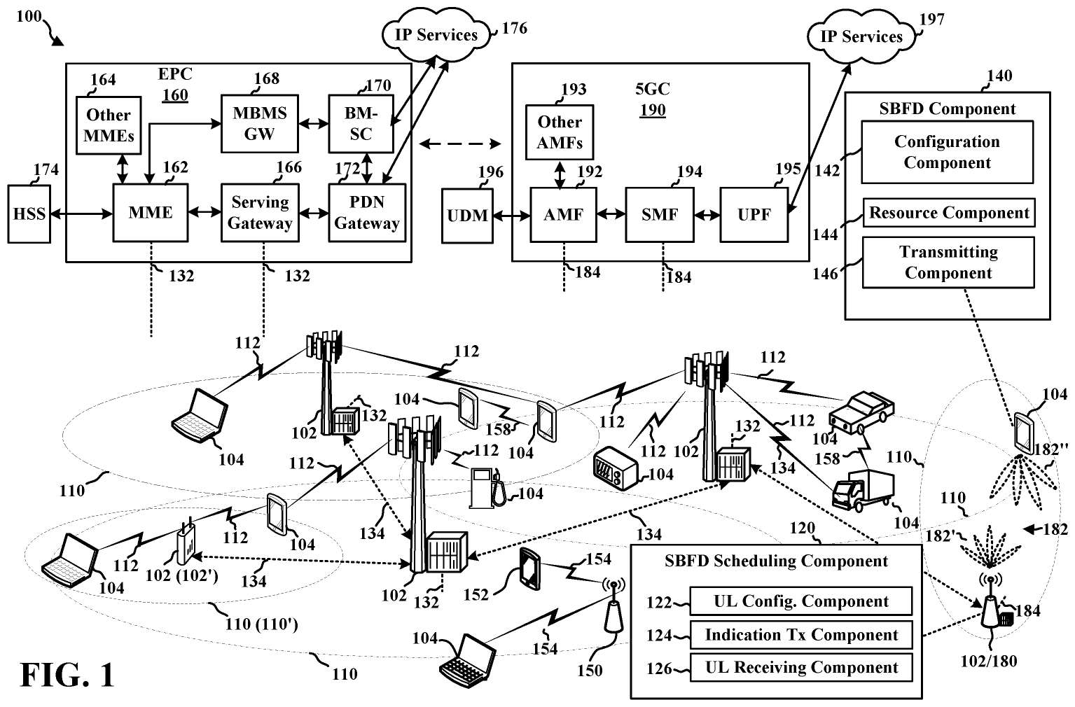

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

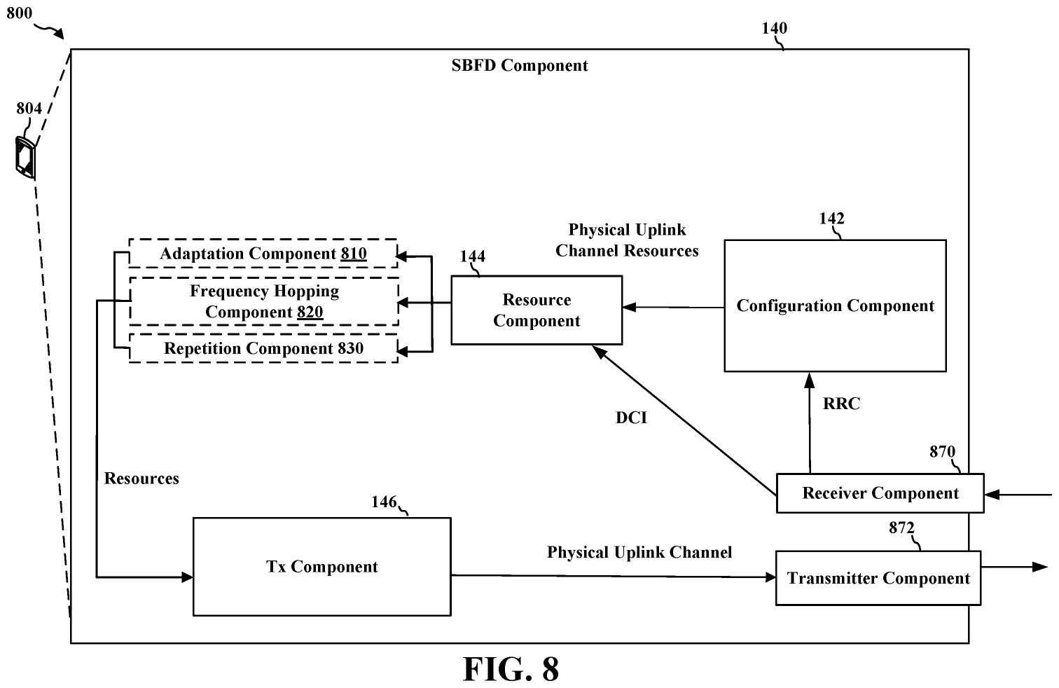

One or more of the UEs 104 may include a SBFD component 140 configured to transmit a physical UL channel on SBFD symbols. The SBFD component 140 may include a configuration component 142 configured to receive a configuration of a physical UL channel. The configuration is applicable to SBFD symbols and to non-SBFD symbols. The SBFD component 140 may include a resource component 144 configured to receiving an indication of resources for transmission on at least a slot configured with the SBFD symbols. The SBFD component 140 may include a transmitting component 146 configured to determine whether to transmit the physical UL channel on the resources based on whether all resource blocks of the physical UL channel are within an UL sub-band. Additional components of the UE 104 and the SBFD component 140 are illustrated in FIG. 8.

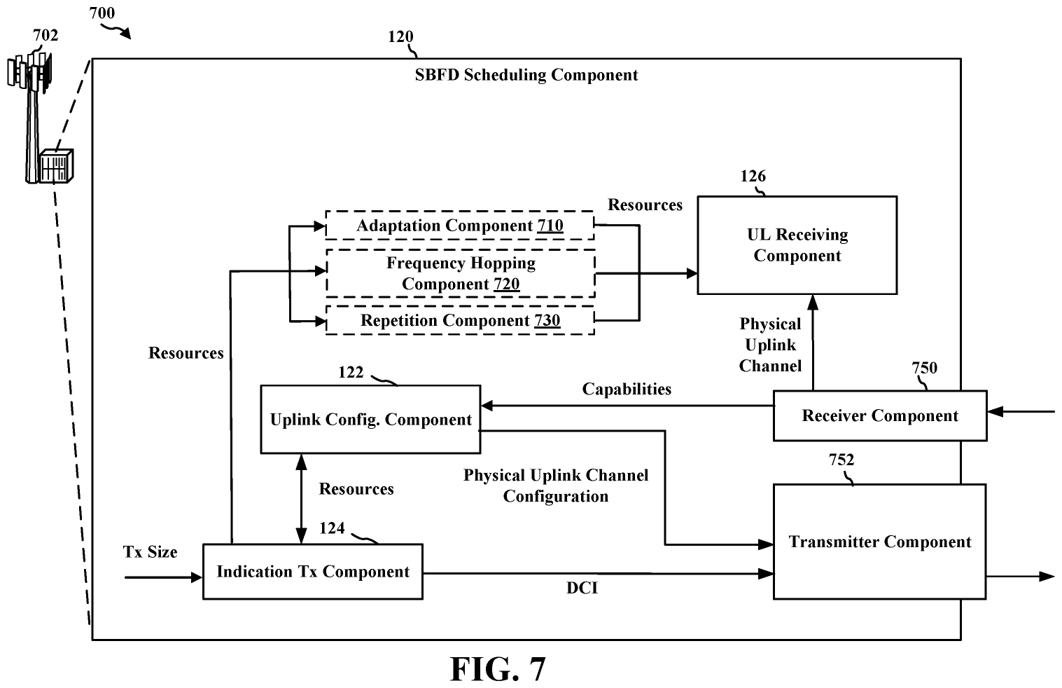

In an aspect, one or more of the base stations 102 may include a SBFD scheduling component 120 that performs the actions of the base station as described herein. For example, the SBFD scheduling component 120 may include an UL configuration component 122 configured to transmit to a UE, a configuration of a physical UL channel, the configuration being applicable to SBFD symbols and to non-SBFD symbols. The SBFD scheduling component 120 may include an indication Tx component 124 configured to transmit an indication of resources for transmission on at least a slot configured with the SBFD symbols. The SBFD scheduling component 120 may include a UL receiving component 126 configured to determine whether the UE transmits the physical UL channel on the resources based on whether all resource blocks of the physical UL channel are within an UL sub-band. Additional components of the base station 102 and SBFD scheduling component 120 are illustrated in FIG. 7.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150.

The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

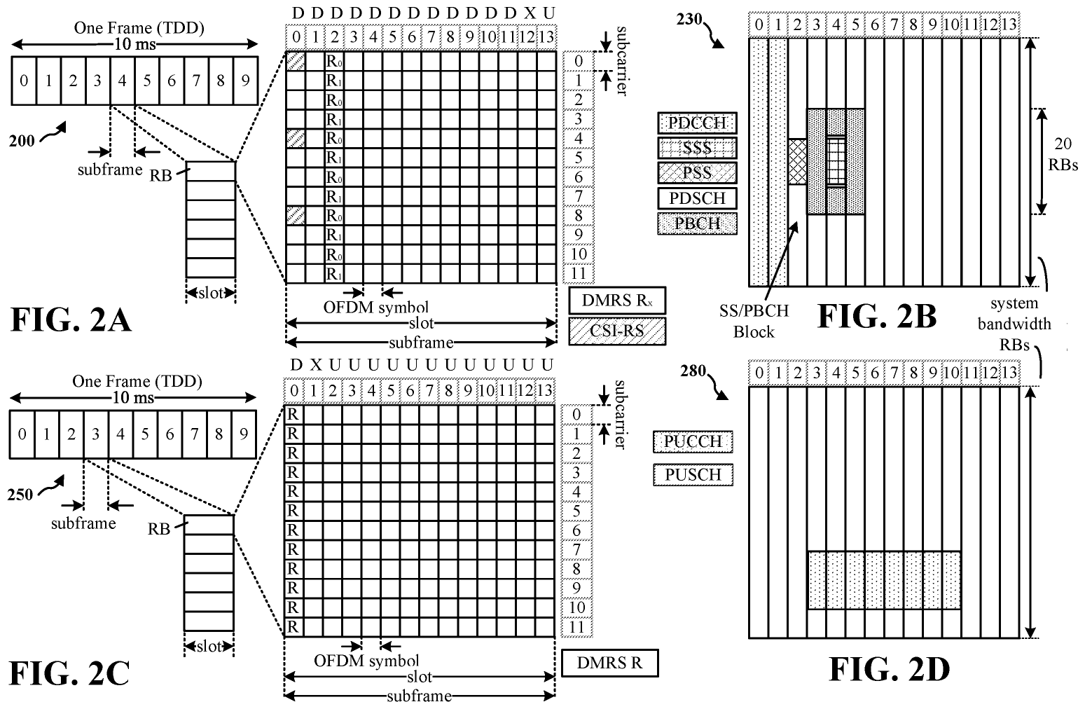

FIGS. 2A-2D are resource diagrams illustrating example frame structures and channels that may be used for UL, DL, and sidelink transmissions to a UE 104 including a SBFD component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical UL control channel (PUCCH) and DM-RS for the physical UL shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries UL control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

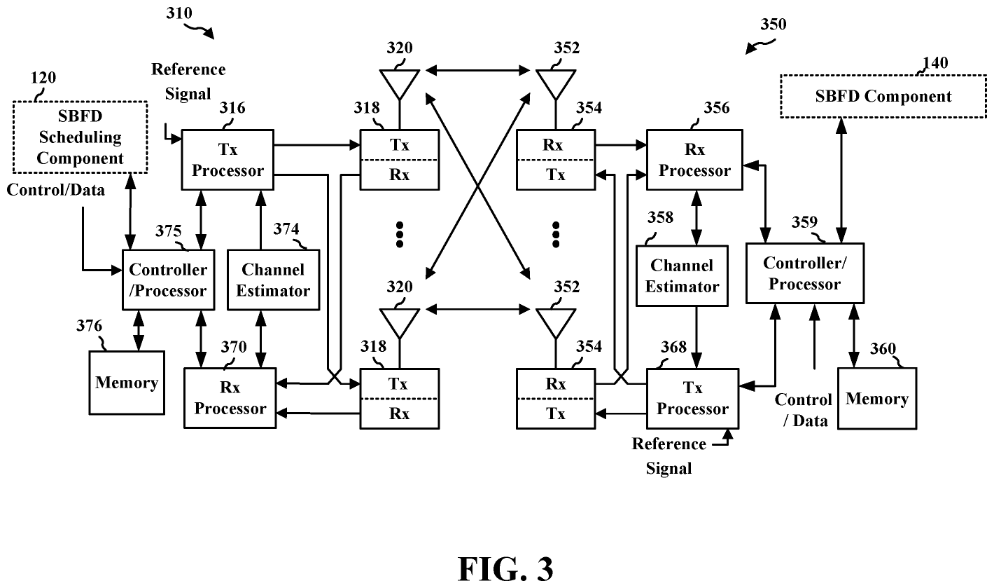

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the SBFD component 140 of FIG. 1. For example, the memory 360 may include executable instructions defining the SBFD component 140. The Tx processor 368, the Rx processor 356, and/or the controller/processor 359 may be configured to execute the SBFD component 140.

At least one of the Tx processor 316, the Rx processor 370, and the controller/processor 375 may be configured to perform aspects in connection with the SBFD scheduling component 120 of FIG. 1. For example, the memory 376 may include executable instructions defining the SBFD scheduling component 120. The Tx processor 316, the Rx processor 370, and/or the controller/processor 375 may be configured to execute the SBFD scheduling component 120.

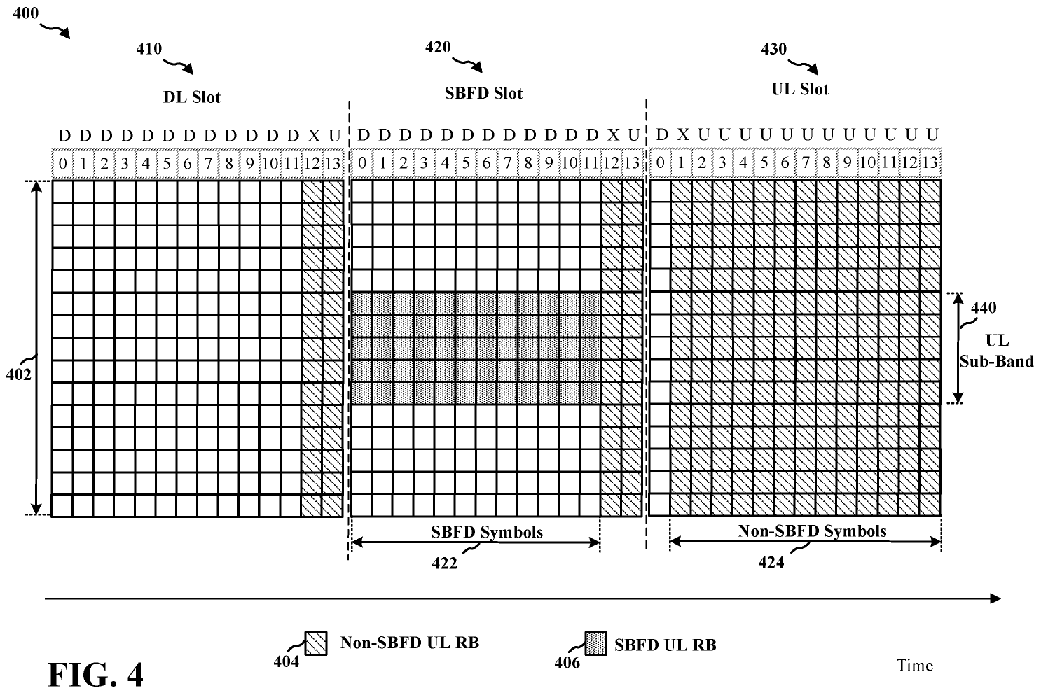

FIG. 4 is a resource diagram 400 illustrating available UL resources for different slot types. A bandwidth part 402 may include a number of RBs. A SBFD configuration may indicate an UL sub-band 440 and time-domain resources that are configured for SBFD. Generally, the UL sub-band 440 is located near the middle of the bandwidth part 402 such that the UL sub-band 440 is separated from other frequency domain resources by DL sub-bands. It should be understood that number of RBs in the bandwidth part 402 and the UL sub-band 440 is merely illustrative and that larger or smaller numbers may be configured.

The UL resources may include SBFD UL RBs 406 on SBFD symbols 422 and non-SBFD UL RBs 404 on non-SBFD symbols 424, which include flexible (X) symbols and uplink (U) symbols. The SBFD symbols 422 may be DL symbols or X symbols configured with an UL sub-band 440. Accordingly, only the SBFD UL RBs 406 located in the UL sub-band 440 may be used for UL transmission in the SBFD symbols 422.

Slot 410 is a DL-centric slot (e.g., slot format 34) without SBFD configuration. Only symbols 12 and 13 may be used for UL transmission. Slot 430 is an UL-centric slot (e.g., slot format 28), where symbols 1-13 may be used for UL transmission.

Slot 420 is an SBFD slot. Although slot 420 has the same slot format as the slot 410, slot 420 is configured for SBFD using the UL sub-band 440. Accordingly, in slot 420, the SBFD symbols 422 may be used for UL transmission on the SBFD UL RBs and for DL transmission on the rest of the RBs.

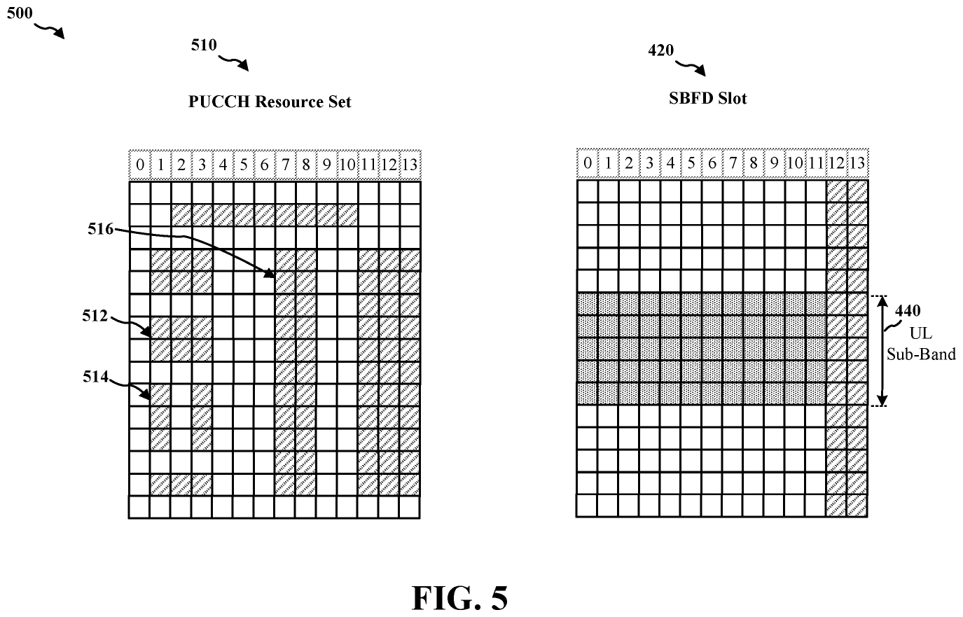

FIG. 5 is a resource diagram 500 illustrating an example of a PUCCH resource set 510 in comparison to UL resources in an example SBFD slot 420. The PUCCH resource set 510 may be configured as part of a PUCCH configuration. The PUCCH resource set 510 may define one or more PUCCH resources that may be selected for a PUCCH transmission based on a size of an UL control information (UCI) payload. For example, a PUCCH resource set 510 may include up to 12 PUCCH resources (8 illustrated). A base station may select the PUCCH resources for transmission using an indication such as a DCI that includes a PRI field. For an UL slot (e.g., slot 430), all of the configured PUCCH resources in the PUCCH resource set 510 may be within the non-SBFD UL RBs. For a SBFD slot 420, however, not all of the configured PUCCH resources in the PUCCH resource set 510 may be within the SBFD RBs. For example, only the PUCCH resource 512 may be entirely within the UL sub-band 440. Additionally, in the case of intra-slot frequency hopping, inter-slot frequency hopping, and/or repetition, the PUCCH resource 512 may not be within the UL sub-band 440 on some symbols.

A PUSCH may also be scheduled in a manner that does not align with SBFD RBs. For example, when a PUSCH is configured via a configured grant or scheduled by DCI, with transport block (TB) processing over multiple slots, intra-slot frequency hopping, inter-slot frequency hopping, and/or repetition, the indicated resources may not be within an UL sub-band 440.

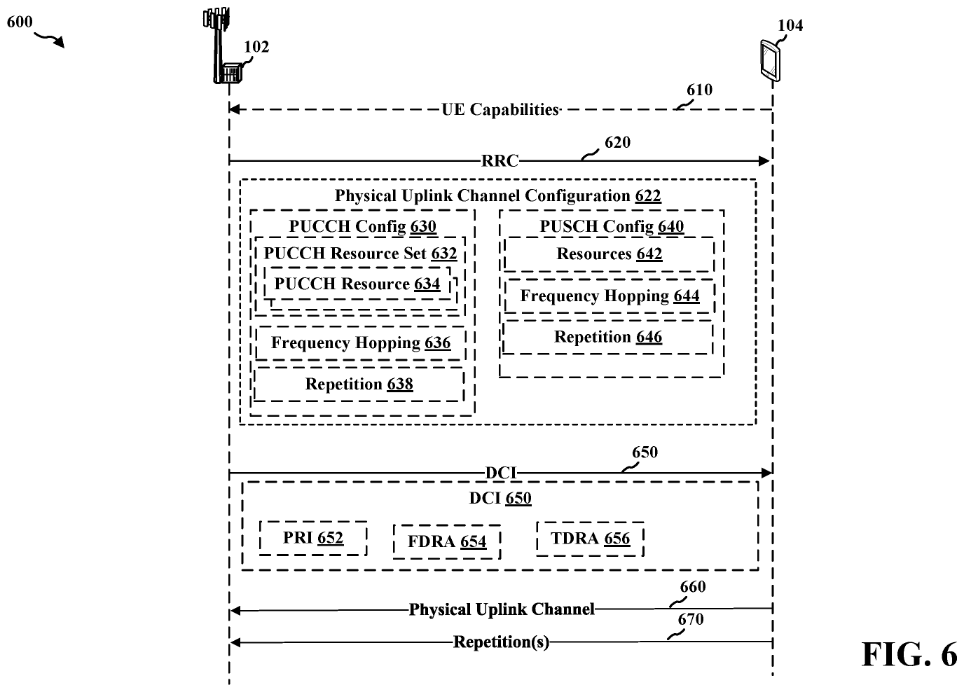

FIG. 6 is a message diagram 600 illustrating example messages for transmission of UL physical channels. A base station 102 may be a serving base station for a UE 104. The UE 104 may transmit UE capabilities 610 indicating a capability of the UE 104 for SBFD.

The base station 102 may configure the UE 104 with a physical UL channel configuration 622. For example, the base station 102 may transmit the physical UL channel configuration 622 via RRC signaling 620. The physical UL channel configuration 622 may include, for example, a PUCCH configuration 630 and/or a PUSCH configuration 640. The PUCCH configuration 630 may include one or more PUCCH resource sets 632 defining one or more PUCCH resources 634. For example, the PUCCH resource sets 632 may correspond to the PUCCH resource set 510 and the PUCCH resources 634 may correspond to one of the PUCCH resources 512, 514, or 516. The PUCCH configuration 630 may include frequency hopping parameters 636 that indicate whether the PUCCH is configured with intra-slot frequency hopping and/or inter-slot frequency hopping. The frequency hopping parameters 636 may define a second hop offset. The PUCCH configuration 630 may include repetition parameters 638.

The PUSCH configuration 640 may include resources 642, a frequency hopping parameters 644, and/or repetition parameters 646. The resources 642 may indicate a starting resource block for a PUSCH transmission. The frequency hopping parameters 644 may include a list of candidate of RB offsets for the second hop. The repetition parameters 646 may include a number of repetitions.

The base station 102 may transmit an indication of resources for transmission. For example, the indication may be a DCI 650. The DCI 650 may include a PRI 652 that indicates a PUCCH resource index (e.g., PUCCH resource 512). The DCI 650 may include a FDRA 654 and a TDRA 656 that indicate resources for a PUSCH. As discussed above, when the physical UL channel configuration 622 is applicable to both SBFD symbols 422 and non-SBFD symbols 424, the resources indicated by the DCI 650 may not be within the UL sub-band 440.

When the DCI 650 indicates resources including SBFD symbols 422, the UE 104 may determine whether to transmit a physical UL channel 660 on the resources indicated by the DCI 650 based on whether all RBs of the physical UL channel 660 are within the UL sub-band 440. In some implementations, the UE 104 may determine to drop the physical UL channel 660 when any RBs of the physical UL channel 660 are not within the UL sub-band. In some implementations, the UE 104 may adapt the resources indicated by the DCI 650 to accommodate all resource blocks of the physical UL channel 660 within the UL sub-band. When the physical UL channel configuration 622 includes the repetition parameters 638 or 646, the UE 104 may also determine whether to transmit the repetitions 670 based on whether all RBs of the repetition 670 are within the UL sub-band 440.

In some implementations, adapting the resources to accommodate all resource blocks of the physical UL channel within the UL sub-band may include adjusting a starting physical resource block (PRB) of the resources by an offset that is configured by a network or derived by the UE. For example, the PUCCH resources 634 or resources 642 may be defined by a starting PRB, a number of RBs, and a number of symbols. For instance, referring to FIG. 5, the resource 514 may have a starting RB that is outside of the UL sub-band 440. The offset may be a number of RBs (e.g., 2) to shift the resource 514 in the frequency domain. In some implementations, the PUCCH configuration 630 may include the offset. In some implementations, UE 104 may determine the offset, for example, as a minimum number of RBs to shift the resource 514 to be within the UL sub-band 440. The offset may be positive or negative. Alternatively, the RB offset could be determined by the UE as the first RB in the UL sub-band. In that case, the start RB and the RB offset for the UL transmission could be interpreted with reference to the lowest RB index in of the UL sub-band.

In some implementations, adapting the resources may include selecting a starting resource block and a number of resource blocks for the resources from a list of resources for non-SBFD symbols and for SBFD symbols. For example, the PUCCH configuration 630 may define a list of sets of starting PRB and number of RBs. The sets in the list may be associated with SBFD symbols and non-SBFD symbols. The UE 104 may select the corresponding set from the list. In some cases, a resource (e.g., PUCCH resource 516) may include a number of resources greater than a number of RBs in the UL sub-band. The UE may adjust a number of symbols based on the number of resource blocks to maintain a same size of the resources. For example, the UE 104 may adapt the resource 516 for transmission over 4 symbols on the UL sub-band 440 to transmit the same number of RBs. Alternatively, the UE may adapt the time-domain resources based on a number of RBs to maintain a maximum coding rate of the physical channel specific to SBFD symbols.

In some implementations, the resources on the slot configured with SBFD symbols are configured with a starting resource block (e.g., startRB-SBFD) and a number of resource blocks (e.g., nrofRBs-SBFD) specific to the SBFD symbols. The resources on the slot configured with SBFD symbols may also be configured with a start symbol (e.g., startSymbol_SBFD) and a number of symbols (e.g., noSymbols_SBFD) specific to the SBFD symbols.

In some implementations, the resources on the slot configured with SBFD symbols are configured with a starting resource block applicable to both non-SBFD symbols and SBFD symbols, a starting resource block specific to the SBFD symbols, or both. The resources on the slot configured with SBFD symbols are configured with a number of RBs applicable to both non-SBFD symbols and SBFD symbols, a number of RBs specific to the SBFD symbols, or both.

Intra-slot frequency hopping may include changing the frequency of a transmission within a slot. That is, different symbols of the transmission may be transmitted on different RBs. The change in frequency may be configured as a second hop PRB in the frequency hopping parameters 636 or 644.

Intra-slot frequency hopping may result in indication of resources that are outside of the UL sub-band 440 on SBFD symbols 422. In some implementations, intra-slot frequency hopping may be disabled on the SBFD symbols 422. In some implementations, intra-slot frequency hopping may be selectively disabled when at least one physical resource block of the configured second hop physical resource blocks is outside of the UL sub-band.

In some implementations, the UE 104 may adapt the resources for intra-slot frequency hopping. For example, the UE 104 may apply a same offset to both a starting PRB of the resources and to a second hop PRB. In some implementations, the UE 104 may apply a first offset to a starting PRB of the resources and apply a second offset to a second hop PRB. In some implementations, the UE is configured with a starting PRB and second hop PRB specific to the SBFD symbols (e.g., in frequency hopping parameters 636 or 644), in which case intra-slot frequency hopping is enabled. The UE 104 may also be configured with a number of RBs specific to the SBFD symbols. In some implementations, the UE is configured with a list of starting PRB, second hop PRB, and number of resource blocks. The list includes at least a first set of values applicable to the non-SBFD symbols and a second set of values applicable to the SBFD symbols. In some implementations, the physical UL channel is scheduled or activated by a DCI 650 that indicates a selected second hop PRB for the physical UL channel 660.

Repetition may include repeating a physical UL channel on a second set of resources (e.g., in another slot) based on the resources indicated by the DCI 650. The UE may determine the second set of resources based on whether a slot is considered an available slot. For instance, an UL slot may be considered an available slot. In some cases, an SBFD slot may also be considered an available slot. The UE may determine whether to transmit the physical UL channel 660 on the slot configured with the SBFD symbols (e.g., slot 420) with a configured or indicated number of repetitions based on whether the slot 420 is considered an available slot for repetition.

In some implementations, an SBFD slot 420 may always be considered an available slot for repetition. If any resource blocks of the repetition are outside of the UL sub-band, the UE 104 may drop the repetition of the physical UL channel on the SBFD slot 420. Alternatively, the UE 104 may adapt the resources for the repetition to accommodate all resource blocks of the repetition within the UL sub-band 440. For example, a definition of an available slot in unpaired spectrum may be applicable to a number of PUCCH repetition slots for a PUCCH transmission starting from a slot indicated to the UE for HARQ-ACK reporting, or a slot determined for SR reporting or for CSI reporting and having: an UL symbol, or flexible symbol that is not SS/PBCH block symbol provided by startingSymbolIndex as a first symbol, or SBFD symbol (DL symbol with configured UL sub-band), and consecutive UL symbols, or flexible symbols that are not SS/PBCH block symbols, or DL symbol with configured UL sub-band, starting from the first symbol, equal to or larger than a number of symbols provided by nrofsymbols. If the UE determines that, for a repetition of a PUCCH transmission in a slot, the number of PRB available for the PUCCH transmission is smaller than the value of PRB provided by startingPRB or secondHopPRB and nrofPRBs, for the corresponding PUCCH format, the UE does not transmit the PUCCH repetition in the slot.

Similarly, for PUSCH transmissions with repetition (e.g., when AvailableSlotCounting is enabled, and in case K>1), an available slot may be defined based on tdd-UL-DLConfigurationCommon, tdd-UL-DL-ConfigurationDedicated, UL and DL sub-band configuration and ssb-PositionsInBurst, and the TDRA information field value in the DCI format 0_1 or 0_2. A slot is not counted in the number of NK slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DLConfigurationCommon or tdd-UL-DL ConfigurationDedicated if provided without a configured UL sub-band, or a symbol of an SS/PBCH block with index provided by ssb-PositionsInBurst. If the UE determines that, for a repetition of a PUSCH transmission in a slot, the number of PRB available for the PUSCH transmission is smaller than the value of PRB provided by FDRA bitfield of DCI format 0_1 or 0_2, the UE does not transmit the PUSCH repetition in the slot.

Additionally, PUSCH transmission of a transport block over multiple slots may be based on whether a slot is considered available. The UE determines NK slots for a PUSCH transmission of TB processing over multiple slots scheduled by DCI format 0_1 or 0_2, based on tdd-UL-DL-ConfigurationCommon, tdd-UL-DL-ConfigurationDedicated, UL and DL subband configuration and ssb-PositionsInBurst, and the TDRA information field value in the DCI format 0_1 or 0_2. A slot is not counted in the number of NK slots for a PUSCH transmission of TB processing over multiple slots if at least one of the symbols indicated by the indexed row of the used resource allocation table in the slot overlaps with a DL symbol indicated by tdd-UL-DL-ConfigurationCommon or tdd-UL-DL ConfigurationDedicated if provided without a configured UL subband, or a symbol of an SS/PBCH block with index provided by ssb-PositionsInBurst.

In some implementations, the SBFD slot 420 is considered an available slot for a repetition of the physical UL channel when the SBFD symbols accommodate all resource blocks of the repetition (in both time and frequency domains) within the UL sub-band 440. For example, the SBFD symbols 422 may accommodate all resource blocks of the repetition based on a starting resource block applicable to both non-SBFD symbols and SBFD symbols, a starting resource block specific to the SBFD symbols, or both and a number of resource blocks applicable to both non-SBFD symbols and SBFD symbols, a number of resource blocks specific to the SBFD symbols, or both. In some implementations, the SBFD symbols 422 accommodate all resource blocks of the repetition based on a PRB configuration specific to the SBFD symbols. For example, a definition of an available slot in unpaired spectrum may be applicable to a number of PUCCH repetition slots for a PUCCH transmission starting from a slot indicated to the UE for HARQ-ACK reporting, or a slot determined for SR reporting or for CSI reporting and having: an UL symbol, or flexible symbol that is not SS/PBCH block symbol provided by startingSymbolIndex as a first symbol, or DL symbol with configured UL subband, and consecutive UL symbols, flexible symbols that are not SS/PBCH block symbols, or DL symbols with configured UL sub-band starting from the first symbol, equal to or larger than a number of symbols provided by nrofsymbols; and consecutive PRBs available for the PUCCH transmission larger than the value of PRBs of the PUCCH provided by startingPRB or secondHopPRB and nrofPRBs, or after applying an offset. Similarly, for PUSCH, the SBFD slot 420 may be considered available if the UL sub-band 440 accomodates the PUSCH FDRA. For instance, transmissions with repetition (e.g., when AvailableSlotCounting is enabled, and in case K>1), an available slot may be defined based on tdd-UL-DLConfigurationCommon, tdd-UL-DL-ConfigurationDedicated, UL and DL subband configuration and ssb-PositionsInBurst, and the TDRA and FDRA information fields value in the DCI format 0_1 or 0_2. A slot is not counted in the number of NK slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DLConfigurationCommon or tdd-UL-DL ConfigurationDedicated if provided without a configured UL sub-band, or a symbol of an SS/PBCH block with index provided by ssb-PositionsInBurst. A slot is not counted in the number of NK slots for PUSCH transmission of a PUSCH repetition Type A scheduled by DCI format 0_1 or 0_2 if at least one of the PRBs indicated by the FDRA bitfield within the UE active UL BWP is outside the UL sub-band 440.

Additionally, PUSCH transmission of a transport block over multiple slots may be based on whether a slot is considered available. The UE determines NK slots for a PUSCH transmission of TB processing over multiple slots scheduled by DCI format 0_1 or 0_2, based on tdd-UL-DL-ConfigurationCommon, tdd-UL-DL-ConfigurationDedicated, UL and DL subband configuration and ssb-PositionsInBurst, and the TDRA and FDRA information fields value in the DCI format 0_1 or 0_2. A slot is not counted in the number of NK slots for a PUSCH transmission of TB processing over multiple slots if at least one of the symbols indicated by the indexed row of the used resource allocation table in the slot overlaps with a DL symbol indicated by tdd-UL-DL-ConfigurationCommon or tdd-UL-DL ConfigurationDedicated if provided without a configured UL sub-band, or a symbol of an SS/PBCH block with index provided by ssb-PositionsInBurst. A slot is not counted in the number of NK slots for PUSCH transmission of a of TB processing over multiple slots scheduled by DCI format 0_1 or 0_2 if at least one of the PRBs indicated by the FDRA bitfield within the UE active UL BWP is outside the UL sub-band 440.

In some implementations, the slot configured with the SBFD symbols is considered an available slot for repetition when a first slot for transmission of the physical UL channel is a slot configured with the SBFD symbols. That is, for a physical UL channel that starts transmission on the SBFD slot 420, the UE 104 may also consider a subsequent SBFD slot 420 to be an available slot. In contrast, for a transmission starting in UL slot 430, the SBFD slot 420 may not be considered an available slot. For example, a definition of an available slot in unpaired spectrum for PUCCH repetition on SBFD symbols may be applicable to a number of PUCCH repetition slots for a PUCCH transmission starting from a slot indicated to the UE for HARQ-ACK reporting, or a slot determined for SR reporting or for CSI reporting and having: an SBFD symbol (DL symbol with configured UL subband) that is not SS/PBCH block symbol provided by startingSymbolIndex as a first symbol, and consecutive SBFD symbols (DL symbol with configured UL subband), that are not SS/PBCH block symbols, starting from the first symbol, equal to or larger than a number of symbols provided by nrofsymbols.

Additionally, PUSCH transmission of a random access message 3 based on a random access response (RAR) grant may be based on whether a slot is considered available. The UE determines NK slots for a PUSCH transmission of a PUSCH repetition Type A scheduled by RAR UL grant, based on tdd-UL-DL-ConfigurationCommon and ssb-PositionsInBurst, UL and DL subband configuration, and the TDRA information field value in the RAR UL grant. A slot is not counted in the number of NK slots for a PUSCH transmission of a PUSCH repetition Type A scheduled by RAR UL grant, if at least one of the symbols indicated by the indexed row of the used resource allocation table in the slot overlaps with a DL symbol indicated by tdd-UL-DL-ConfigurationCommon if provided without a configured UL sub-band, or a symbol of an SS/PBCH block with index provided by ssb-PositionsInBurst.

Inter-slot frequency hopping may include changing the frequency of a transmission at a slot boundary. Typically, PUCCH transmission without repetition is within one slot and does not invoke inter-slot frequency hopping. PUSCH transmissions and PUCCH transmissions with repetition may invoke inter-slot frequency hopping. Similar to intra-slot frequency hopping, the change of frequency may result in resources that are outside of the UL sub-band 440. In some implementations, inter-slot frequency hopping is disabled on the SBFD symbols 422.

In some implementations, the UE 104 may adjust a first PRB of the resources in the slot configured with the SBFD symbols for transmission of the physical UL channel with inter-slot frequency hopping. For example, the UE may adapt the resources for inter-slot frequency hopping by applying a same offset to both a starting PRB of the resources and to a second hop PRB. In some implementations, the UE 104 may adapt the resources for inter-slot frequency hopping by applying a first offset to a starting PRB of the resources and applying a second offset to a second hop PRB. In some implementations, the UE is configured with a starting PRB and second hop PRB specific to the SBFD symbols, and inter-slot frequency hopping is enabled on the slot including the SBFD symbols. In some implementations, the UE is configured with a list of starting PRB, second hop PRB, and number of resource blocks, the list including at least a first set of values applicable to the non-SBFD symbols and a second set of values applicable to the SBFD symbols. In some implementations, the physical UL channel is scheduled or activated by the DCI 650 that indicates a selected second hop PRB for the physical UL channel within the UL sub-band 440. In some implementations, the resources on the SBFD slot 420 are configured with a start symbol and a number of symbols specific to the SBFD symbols 422.

FIG. 7 is a conceptual data flow diagram 700 illustrating the data flow between different means/components in an example base station 702, which may be an example of the base station 102 including the SBFD scheduling component 120. The SBFD scheduling component 120 includes the UL configuration component 122, the indication transmitting component 124, and the UL receiving component 126. The SBFD scheduling component 120 may optionally include an adaptation component 710, a frequency hopping component 720, and/or a repetition component 730.

The base station 702 may include a receiver component 750 and a transmitter component 752. The receiver component 750 may include, for example, a RF receiver for receiving the signals described herein. The transmitter component 752 may include for example, an RF transmitter for transmitting the signals described herein. In some implementations, the receiver component 750 and the transmitter component 752 may be co-located in a transceiver such as the Tx/Rx 318 in FIG. 3.

The receiver component 750 may receive UL signals from one or more UEs 104. For example, the receiver component 750 may receive UE capabilities 610, the physical UL channel 660, and/or the repetitions 670. The receiver component 750 may provide the UE capabilities 610 to the UL configuration component 122. The receiver component 750 may provide the physical UL channel 660, and/or the repetitions 670 to the UL receiving component 126.

The UL configuration component 122 may be configured to transmit, to a UE 104, a physical UL channel configuration 622. The UL configuration component 122 may receive capabilities 610 for a UE via the receiver component 750. For instance, the capabilities 610 may indicate a capability for SBFD. The UL configuration component 122 may determine to configure the UE 104 for transmission of a physical UL channel such as PUCCH or PUSCH on SBFD symbols. The UL configuration component 122 may generate the physical UL channel configuration 622. The physical UL channel configuration 622 may be applicable to both SBFD symbols 422 and to non-SBFD symbols 424. In some implementations, the physical UL channel configuration 622 may include one or more parameters that are specific to SBFD symbols 422. The UL configuration component 122 may transmit the physical UL channel configuration 622 to the UE 104 via the transmitter component 752.

The indication Tx component 124 may be configured to transmit an indication of resources for transmission on at least a slot configured with the SBFD symbols. For example, the indication Tx component 124 may receive an indication of a transmission size and other transmission parameters from a higher layer scheduler. For instance, the transmission size may be based on a scheduling request from the UE 104. The indication Tx component 124 may determine a number of RBs for the transmission. The indication Tx component 124 may select RBs for the transmission based on the PUCCH resource set 632 or resources 642. The selected resources may include SBFD symbols. The indication Tx component 124 may generate the DCI 650 to indicate the selected resources. The indication Tx component 124 may transmit the DCI 650 via the transmitter component 752. The indication Tx component 124 may also indicate the selected resources to the UL receiving component 126.

In some implementations, the SBFD scheduling component 120 may optionally include one or more of the adaptation component 710, the frequency hopping component 720, or the repetition component 730, each of which may receive the indication of the resources for a transmission.

The adaptation component 710 may be configured to adapting the resources to accommodate all resource blocks of the physical UL channel within the UL sub-band. For example, the adaptation component 710 may determine whether resources that are outside of the UL sub-band 440 can be adapted based on an offset or SBFD specific parameters as discussed above. The adaptation component 710 may output the adapted resources to the UL receiving component 126.

The frequency hopping component 720 may be configured to determine whether intra-slot or inter-slot frequency hopping applies to the physical UL channel. For example, the frequency hopping component 720 may evaluate the frequency hopping parameters 636 or 644 to determine whether a second hop would be within the UL sub-band 440. The frequency hopping component 720 may disable frequency hopping or adapt the frequency hopping parameters to use RBs within the UL sub-band 440. The frequency hopping component 720 may output the resources accounting for frequency hopping to the UL receiving component 126.

The repetition component 730 may determine whether the physical UL channel is repeated on an available slot. For example, the repetition component 730 may determine whether the SBFD slot 420 is considered an available slot for repetition based on the resources received from the indication Tx component 124. The repetition component 730 may output additional resources for repetitions to the UL receiving component 126.

The UL receiving component 126 may be configured to determine whether the UE transmits the physical UL channel on the resources based on whether all resource blocks of the physical UL channel are within an UL sub-band. For example, the UL receiving component 126 may receive the resources output by the indication Tx component 124 or adapted, modified, or additional resources determined by the adaptation component 710, frequency hopping component 720, or the repetition component 730. If the resources are within the UL sub-band 440, the UL receiving component 126 may determine that the UE 104 transmits the physical UL channel on the resource. The UL receiving component 126 may receive the physical UL channel on the SBFD symbols 422 within the UL sub-band 440.

FIG. 8 is a conceptual data flow diagram 800 illustrating the data flow between different means/components in an example UE 804, which may be an example of the UE 104 and include the SBFD component 140.

As discussed with respect to FIG. 1, the SBFD component 140 may include the configuration component 142, the resource component 144, and the transmitting component 146. The SBFD scheduling component 120 may optionally include an adaptation component 710, a frequency hopping component 720, and/or a repetition component 730.

The UE 104 also may include a receiver component 870 and a transmitter component 872. The receiver component 870 may include, for example, a RF receiver for receiving the signals described herein. The transmitter component 872 may include for example, an RF transmitter for transmitting the signals described herein. In some implementations, the receiver component 870 and the transmitter component 872 may be co-located in a transceiver.

The receiver component 870 may receive DL signals such as the RRC signaling 620, the physical UL channel configuration 622, and the RRC signaling 620 and the DCI 650. The receiver component 870 may provide the RRC signaling 620 to the configuration component 142. The receiver component 870 may provide the DCI 650 to the resource component 144.

The configuration component 142 is configured to receive the physical UL channel configuration 622. For example, the configuration component 142 may receive the RRC signaling 620 via the receiver component 870. The configuration component 142 may extract the physical UL channel configuration 622 from the RRC signaling 620, for example, by decoding the RRC signaling. For example, the configuration component 142 may extract parameters of the PUCCH configuration 630 or the PUSCH configuration 640. The physical UL channel configuration 622 may be applicable to both SBFD symbols 422 and non-SBFD symbols 424. In some implementations, the physical UL channel configuration 622 may include one or more parameters that are specific to the SBFD symbols 422. The parameters (e.g., PUCCH resource set 632 or resources 642) may define available resources for transmitting the physical UL channel. The configuration component 142 may provide the configured resources to the resource component 144.

The resource component 144 is configured to receive an indication of resources for transmission on at least a slot configured with the SBFD symbols. For example, the resource component 144 may receive the DCI 650 via the receiver component 870. For instance, the resource component 144 may perform blind decoding to detect a DCI format. The DCI 650 may include one or more fields such as PRI 652 or FDRA 654 and TDRA 656 that allocates resources for a physical UL channel. The resource component 144 may output the indicated resources to the transmitting component 146.

In some implementations, the SBFD component 140 may optionally include one or more of the adaptation component 810, the frequency hopping component 820, or the repetition component 830, each of which may receive the indicated resources for a transmission from the resource component 144. The adaptation component 810, the frequency hopping component 820, and the repetition component 830 may be similar to the corresponding adaptation component 710, the frequency hopping component 720, or the repetition component 730 at the base station 702. Accordingly, the SBFD component 140 may adapt the indicated resources in the same manner as the SBFD scheduling component 120 such that the base station 102 and the UE 104 are in agreement on the resources for the UL physical channel.

The adaptation component 810 may be configured to adapt the resources to accommodate all resource blocks of the physical UL channel within the UL sub-band. For example, the adaptation component 810 may determine whether resources that are outside of the UL sub-band 440 can be adapted based on an offset or SBFD specific parameters as discussed above. The adaptation component 810 may output the adapted resources to the transmitting component 146.

The frequency hopping component 820 may be configured to determine whether intra-slot or inter-slot frequency hopping applies to the physical UL channel. For example, the frequency hopping component 820 may evaluate the frequency hopping parameters 636 or 644 to determine whether a second hop would be within the UL sub-band 440. The frequency hopping component 820 may disable frequency hopping or adapt the frequency hopping parameters to use RBs within the UL sub-band 440. The frequency hopping component 820 may output the resources accounting for frequency hopping to the transmitting component 146.

The repetition component 830 may determine whether the physical UL channel is repeated on an available slot. For example, the repetition component 830 may determine whether the SBFD slot 420 is considered an available slot for repetition based on the resources received from the resource component 144. The repetition component 830 may output additional resources for repetitions to the transmitting component 146.

The transmitting component 146 may be configured to determine whether to transmit the physical UL channel on the resources based on whether all resource blocks of the physical UL channel are within an UL sub-band. In some implementations, the transmitting component 146 may drop (e.g., not transmit) the physical UL channel when all resource blocks of the physical UL channel are not within the UL sub-band. When the adaptation component 810, the frequency hopping component 820, or the repetition component 830 adapts the resources to accommodate all resource blocks of the physical UL channel within the UL sub-band 440, the transmitting component 146 may transmit the physical UL channel on the adapted resources. The transmitting component 146 may output the UL physical channel for transmission on the SBFD symbols 422 within the UL sub-band 440.

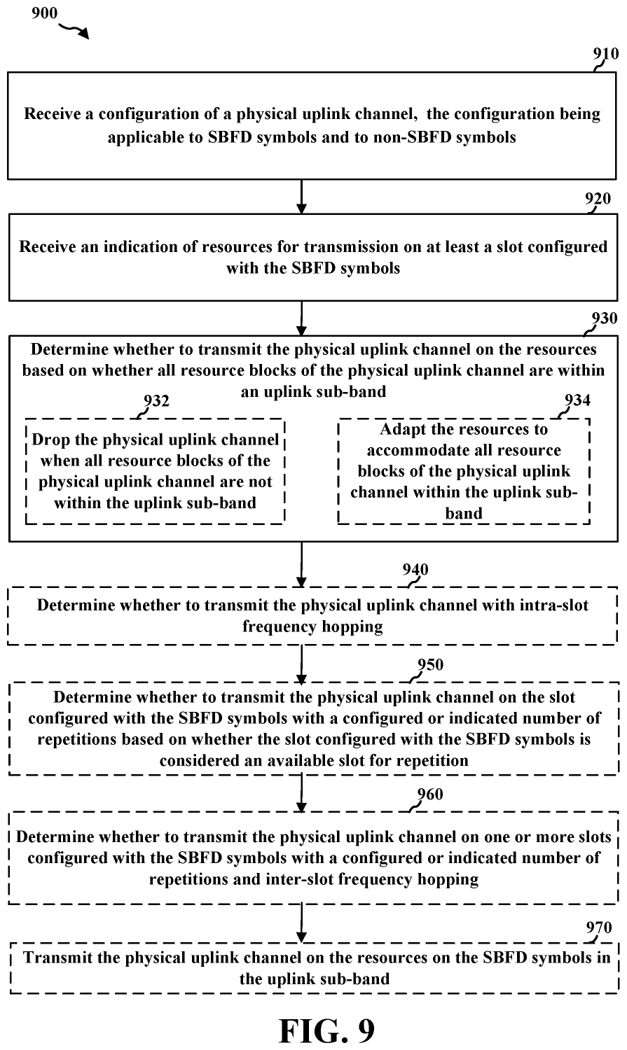

FIG. 9 is a flowchart of an example method 900 for a UE to transmit a physical UL channel on SBFD symbols. The method 900 may be performed by a UE (such as the UE 104, which may include the memory 360 and which may be the entire UE 104 or a component of the UE 104 such as the SBFD component 140, Tx processor 368, the Rx processor 356, or the controller/processor 359). The method 900 may be performed by the SBFD component 140 in communication with the SBFD scheduling component 120 of the base station 102. Optional blocks are shown with dashed lines.

At block 910, the method 900 includes receiving a configuration of a physical UL channel, the configuration being applicable to SBFD symbols and to non-SBFD symbols. In some implementations, for example, the UE 104, the Rx processor 356, or the controller/processor 359 may execute the SBFD component 140 or the configuration component 142 to receive the physical UL channel configuration 622. The physical UL channel configuration 622 is applicable to SBFD symbols 422 and to non-SBFD symbols 424. Accordingly, the UE 104, the Rx processor 356, or the controller/processor 359 executing the SBFD component 140 or the configuration component 142 may provide means for receiving a configuration of a physical UL channel, the configuration being applicable to SBFD symbols and to non-SBFD symbols.

At block 920, the method 900 includes receiving an indication of resources for transmission on at least a slot configured with the SBFD symbols. In some implementations, for example, the UE 104, the Rx processor 356, or the controller/processor 359 may execute the SBFD component 140 or the resource component 144 to receive the DCI 650 including an indication of resources for transmission (e.g., PRI 652, FDRA 654, or TDRA 656) on at least a slot 420 configured with the SBFD symbols. Accordingly, the UE 104, the Rx processor 356, or the controller/processor 359 executing the SBFD component 140 or resource component 144 may provide means for receiving an indication of resources for transmission on at least a slot configured with the SBFD symbols.

At block 930, the method 900 includes determining whether to transmit the physical UL channel on the resources based on whether all resource blocks of the physical UL channel are within an UL sub-band. In some implementations, for example, the UE 104, the Tx processor 368, or the controller/processor 359 may execute the SBFD component 140 and/or the transmitting component 146 determine whether to transmit the physical UL channel on the resources based on whether all resource blocks of the physical UL channel are within the UL sub-band 440. For example, at sub-block 932, the block 930 may optionally include dropping the physical UL channel when all resource blocks of the physical UL channel are not within the UL sub-band. As another example, in sub-block 934, the block 930 may optionally include adapting the resources to accommodate all resource blocks of the physical UL channel within the UL sub-band. Accordingly, the UE 104, the Tx processor 368, or the controller/processor 359 executing the SBFD component 140 or the transmitting component 146 may provide means for determining whether to transmit the physical UL channel on the resources based on whether all resource blocks of the physical UL channel are within an UL sub-band.

At block 940, the method 900 may optionally include determining whether to transmit the physical UL channel with intra-slot frequency hopping. In some implementations, for example, the UE 104, the Tx processor 368, or the controller/processor 359 may execute the SBFD component 140 and/or the frequency hopping component 820 to determine whether to transmit the physical UL channel with intra-slot frequency hopping. Accordingly, the UE 104, the Tx processor 368, or the controller/processor 359 executing the SBFD component 140 or the hopping component 820 may provide means for determining whether to transmit the physical UL channel with intra-slot frequency hopping.

At block 950, the method 900 may optionally determining whether to transmit the physical UL channel on the slot configured with the SBFD symbols with a configured or indicated number of repetitions based on whether the slot configured with the SBFD symbols is considered an available slot for repetition. In some implementations, for example, the UE 104, the Tx processor 368, or the controller/processor 359 may execute the SBFD component 140 and/or the repetition component 830 to determine whether to transmit the physical UL channel on the slot configured with the SBFD symbols with a configured or indicated number of repetitions based on whether the slot configured with the SBFD symbols is considered an available slot for repetition. Accordingly, the UE 104, the Tx processor 368, or the controller/processor 359 executing the SBFD component 140 or the repetition component 830 may provide means for determining whether to transmit the physical UL channel on the slot configured with the SBFD symbols with a configured or indicated number of repetitions based on whether the slot configured with the SBFD symbols is considered an available slot for repetition.

At block 960, the method 900 may optionally determining whether to transmit the physical UL channel on the slot configured with the SBFD symbols with a configured or indicated number of repetitions based on whether the slot configured with the SBFD symbols is considered an available slot for repetition. In some implementations, for example, the UE 104, the Tx processor 368, or the controller/processor 359 may execute the SBFD component 140 and/or the frequency hopping component 820 to determine whether to transmit the physical UL channel on one or more slots configured with the SBFD symbols with a configured or indicated number of repetitions and inter-slot frequency hopping. Accordingly, the UE 104, the Tx processor 368, or the controller/processor 359 executing the SBFD component 140 or the frequency hopping component 820 may provide means for determining whether to transmit the physical UL channel on one or more slots configured with the SBFD symbols with a configured or indicated number of repetitions and inter-slot frequency hopping.

At block 970, the method 900 may optionally include transmitting the physical UL channel on the resources on the SBFD symbols within the UL sub-band. In some implementations, for example, the UE 104, the Tx processor 368, or the controller/processor 359 may execute the SBFD component 140 or the transmitter component 872 to transmit the physical UL channel 660 or a repetition 670 on the resources (e.g., SBFD UL RBs 406) on the SBFD symbols 422 within the UL sub-band 440. Accordingly, the UE 104, the Tx processor 368, or the controller/processor 359 executing the SBFD component 140 or the transmitter component 872 may provide means for transmitting the physical UL channel on the resources on the SBFD symbols within the UL sub-band.

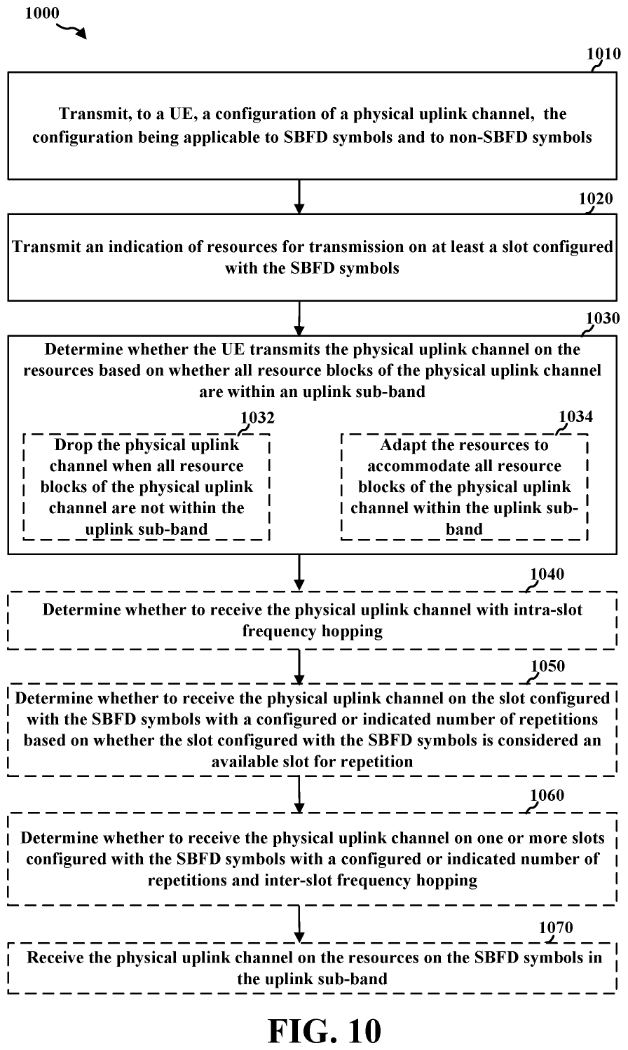

FIG. 10 a flowchart of an example method 1000 for a base station to receive an UL from a UE on SBFD symbols. The method 1000 may be performed by a base station (such as the base station 102, which may include the memory 376 and which may be the entire base station 102 or a component of the base station 102 such as the SBFD scheduling component 120, Tx processor 316, the Rx processor 370, or the controller/processor 375). The method 1000 may be performed by the SBFD scheduling component 120 in communication with the SBFD component 140 of the first UE 104. Optional blocks are shown with dashed lines.

At block 1010, the method 1000 includes transmitting to a UE, a configuration of a physical UL channel, the configuration being applicable to SBFD symbols and to non-SBFD symbols. In some implementations, for example, the base station 102, Tx processor 316, or the controller/processor 375 may execute the SBFD scheduling component 120 or the UL configuration component 122 to transmit the physical UL channel configuration 622 to the UE 104. The physical UL channel configuration 622 is applicable to SBFD symbols 422 and to non-SBFD symbols. 424. Accordingly, the base station 102, Tx processor 316, or the controller/processor 375 executing the SBFD scheduling component 120 or the UL configuration component 122 may provide means for transmitting to a UE, a configuration of a physical UL channel, the configuration being applicable to SBFD symbols and to non-SBFD symbols.

At block 1020, the method 1000 includes transmitting an indication of resources for transmission on at least a slot configured with the SBFD symbols. In some implementations, for example, the base station 102, Tx processor 316, or the controller/processor 375 may execute the SBFD scheduling component 120 or the indication Tx component 124 to transmit an indication (e.g., DCI 650) of resources for transmission on at least a slot 420 configured with the SBFD symbols 422. Accordingly, the base station 102, the Tx processor 316, or the controller/processor 375 executing the SBFD scheduling component 120 or the indication Tx component 124 may provide means for transmitting an indication of resources for transmission on at least a slot configured with the SBFD symbols.

At block 1030, the method 1000 includes determining whether the UE transmits the physical UL channel on the resources based on whether all resource blocks of the physical UL channel are within an UL sub-band. In some implementations, for example, the base station 102, the Rx processor 370, or the controller/processor 375 may execute the SBFD scheduling component 120 or the UL receiving component 126 to determine whether the UE 104 transmits the physical UL channel 660 on the resources based on whether all resource blocks of the physical UL channel 660 are within the UL sub-band 440. For example, at sub-block 1032, the block 1030 may optionally include dropping (e.g., not receiving) the physical UL channel when all resource blocks of the physical UL channel are not within the UL sub-band. As another example, in sub-block 1034, the block 1030 may optionally include adapting the resources to accommodate all resource blocks of the physical UL channel within the UL sub-band. Accordingly, the base station 102, Rx processor 370, or the controller/processor 375 executing the SBFD scheduling component 120 or the UL receiving component 126 may provide means for determining whether the UE transmits the physical UL channel on the resources based on whether all resource blocks of the physical UL channel are within an UL sub-band.

At block 1040, the method 1000 may optionally include determining whether to transmit the physical UL channel with intra-slot frequency hopping. In some implementations, for example, the base station 102, the Rx processor 370, or the controller/processor 375 may execute the SBFD scheduling component 120 or the frequency hopping component 720 to determine whether to transmit the physical UL channel with intra-slot frequency hopping. Accordingly, the base station 102, Rx processor 370, or the controller/processor 375 executing the SBFD scheduling component 120 or the frequency hopping component 720 may provide means for determining whether to transmit the physical UL channel with intra-slot frequency hopping.

At block 1050, the method 1000 may optionally include determining whether to transmit the physical UL channel on the slot configured with the SBFD symbols with a configured or indicated number of repetitions based on whether the slot configured with the SBFD symbols is considered an available slot for repetition. In some implementations, for example, the base station 102, the Rx processor 370, or the controller/processor 375 may execute the SBFD scheduling component 120 or the repetition component 730 to determine whether to transmit the physical UL channel on the slot configured with the SBFD symbols with a configured or indicated number of repetitions based on whether the slot configured with the SBFD symbols is considered an available slot for repetition. Accordingly, the base station 102, Rx processor 370, or the controller/processor 375 executing the SBFD scheduling component 120 or the repetition component 730 may provide means for determining whether to transmit the physical UL channel on the slot configured with the SBFD symbols with a configured or indicated number of repetitions based on whether the slot configured with the SBFD symbols is considered an available slot for repetition.

At block 1060, the method 1000 may optionally include determining whether to transmit the physical UL channel on one or more slots configured with the SBFD symbols with a configured or indicated number of repetitions and inter-slot frequency hopping. In some implementations, for example, the base station 102, the Rx processor 370, or the controller/processor 375 may execute the SBFD scheduling component 120 or the frequency hopping component 720 to determine whether to transmit the physical UL channel on one or more slots configured with the SBFD symbols with a configured or indicated number of repetitions and inter-slot frequency hopping. Accordingly, the base station 102, Rx processor 370, or the controller/processor 375 executing the SBFD scheduling component 120 or the frequency hopping component 820 may provide means for determining whether to transmit the physical UL channel on one or more slots configured with the SBFD symbols with a configured or indicated number of repetitions and inter-slot frequency hopping.

At block 1070, the method 1000 may optionally include receiving the physical UL channel on the resources on the SBFD symbols in the UL sub-band. In some implementations, for example, the base station 102, Tx processor 316, or the controller/processor 375 may execute the SBFD scheduling component 120 or the receiver component 750 to receive the physical UL channel 660 or a repetition 670 on the resources on the SBFD symbols 422 in the UL sub-band 440. Accordingly, the base station 102, Tx processor 316, or the controller/processor 375 executing the SBFD scheduling component 120 or the receiver component 750 may provide means for receiving the physical UL channel on the resources on the SBFD symbols in the UL sub-band.

The following provides an overview of aspects of the present disclosure:

Aspect 1. A method of wireless communications at a user equipment (UE), comprising: receiving a configuration of a physical uplink channel, the configuration being applicable to sub-band full duplex (SBFD) symbols and to non-SBFD symbols; receiving an indication of resources for transmission on at least a slot configured with the SBFD symbols; and determining whether to transmit the physical uplink channel on the resources based on whether all resource blocks of the physical uplink channel are within an uplink sub-band.

Aspect 2. The method of Aspect 1, wherein all resource blocks of the physical uplink channel are not within the uplink sub-band, further comprising dropping the physical uplink channel.

Aspect 3. The method of Aspect 1, wherein all resource blocks of the physical uplink channel are not within the uplink sub-band, further comprising adapting the resources to accommodate all resource blocks of the physical uplink channel within the uplink sub-band.

Aspect 4. The method of Aspect 3, wherein adapting the resources comprises adjusting a starting physical resource block (PRB) of the resources by an offset that is configured by a network or derived by the UE.

Aspect 5. The method of Aspect 3 or 4, wherein adapting the resources comprises selecting a starting resource block and a number of resource blocks for the resources from a list of resources for non-SBFD symbols and for SBFD symbols.

Aspect 6. The method of Aspect 5, wherein adapting the resources comprises adjusting a number of symbols based on the number of resource blocks to maintain a same size of the resources.

Aspect 7. The method of Aspect 5 or 6, wherein adapting the resources compromises adjusting time domain resources for the number of resource blocks to maintain a maximum coding rate of the physical uplink channel specific to the SBFD symbols.

Aspect 8. The method of any of Aspects 1-7, wherein the resources on the slot configured with SBFD symbols are configured with a starting resource block and a number of resource blocks specific to the SBFD symbols.

Aspect 9. The method of Aspect 8, wherein the resources on the slot configured with SBFD symbols are configured with a start symbol and a number of symbols specific to the SBFD symbols.

Aspect 10. The method of any of Aspects 1-9, wherein the resources on the slot configured with SBFD symbols are configured with a starting resource block applicable to both non-SBFD symbols and SBFD symbols, a starting resource block specific to the SBFD symbols, or both.

Aspect 11. The method of Aspect 10, wherein the resources on the slot configured with SBFD symbols are configured with a number of resource blocks applicable to both non-SBFD symbols and SBFD symbols, a number of resource blocks specific to the SBFD symbols, or both.

Aspect 12. The method of any of Aspects 1-11, further comprising determining whether to transmit the physical uplink channel with intra-slot frequency hopping.

Aspect 13. The method of Aspect 12, wherein determining whether to transmit the physical uplink channel with intra-slot frequency hopping comprises disabling intra-slot frequency hopping on the SBFD symbols.

Aspect 14. The method of Aspect 12, wherein determining whether to transmit the physical uplink channel with intra-slot frequency hopping comprises disabling intra-slot frequency hopping on the SBFD symbols when at least one physical resource block of a set of configured second hop physical resource blocks is outside of the uplink sub-band.

Aspect 15. The method of Aspect 12, wherein determining whether to transmit the physical uplink channel with intra-slot frequency hopping comprises adapting the resources for intra-slot frequency hopping by applying a same offset to both a starting physical resource block (PRB) of the resources and to a second hop PRB.

Aspect 16. The method of Aspect 12, wherein determining whether to transmit the physical uplink channel with intra-slot frequency hopping comprises adapting the resources for intra-slot frequency hopping by applying a first offset to a starting PRB of the resources and applying a second offset to a second hop PRB.

Aspect 17. The method of Aspect 12, wherein the UE is configured with a starting PRB and second hop PRB specific to the SBFD symbols, and wherein intra-slot frequency hopping is enabled.

Aspect 18. The method of Aspect 17, wherein the UE is configured with a number of resource blocks specific to the SBFD symbols.

Aspect 19. The method of Aspect 17, wherein the UE is configured with a list of a starting PRB, a second hop PRB, and a number of resource blocks, the list including at least a first set of values applicable to the non-SBFD symbols and a second set of values applicable to the SBFD symbols.

Aspect 20. The method of Aspect 12, wherein the physical uplink channel is scheduled or activated by a downlink control information (DCI) that indicates a selected second hop PRB for the physical uplink channel.

Aspect 21. The method of any of Aspect 1-20, further comprising determining whether to transmit the physical uplink channel on the slot configured with the SBFD symbols with a configured or indicated number of repetitions based on whether the slot configured with the SBFD symbols is considered an available slot for repetition.

Aspect 22. The method of Aspect 21, wherein the slot configured with the SBFD symbols is considered an available slot for a repetition of the physical uplink channel.

Aspect 23. The method of Aspect 22, further comprising dropping the repetition of the physical uplink channel if any resource blocks of the repetition are outside of the uplink sub-band.

Aspect 24. The method of Aspect 21, further comprising adapting the resources to accommodate all resource blocks of the repetition within the uplink sub-band.

Aspect 25. The method of Aspect 21, wherein the slot configured with the SBFD symbols is considered an available slot for a repetition of the physical uplink channel when the SBFD symbols accommodate all resource blocks of the repetition within the uplink sub-band in both time and frequency domains.

Aspect 26. The method of Aspect 25, wherein the SBFD symbols accommodate all resource blocks of the repetition based on a starting resource block applicable to both non-SBFD symbols and SBFD symbols, a starting resource block specific to the SBFD symbols, or both and a number of resource blocks applicable to both non-SBFD symbols and SBFD symbols, a number of resource blocks specific to the SBFD symbols, or both.

Aspect 27. The method of Aspect 25, wherein the SBFD symbols accommodate all resource blocks of the repetition based on a PRB configuration specific to the SBFD symbols.

Aspect 28. The method of Aspect 21, wherein the slot configured with the SBFD symbols is considered an available slot for repetition when a first slot for transmission of the physical uplink channel is a slot configured with the SBFD symbols.

Aspect 29. The method of any of Aspects 1-28, further comprising determining whether to transmit the physical uplink channel on one or more slots configured with the SBFD symbols with a configured or indicated number of repetitions and inter-slot frequency hopping.

Aspect 30. The method of Aspect 29, wherein inter-slot frequency hopping is disabled on the SBFD symbols.

Aspect 31. The method of Aspect 29, further comprising adjusting a first PRB of the resources in the slot configured with the SBFD symbols for transmission of the physical uplink channel with inter-slot frequency hopping.

Aspect 32. The method of Aspect 31, wherein determining whether to transmit the physical uplink channel with inter-slot frequency hopping comprises adapting the resources for inter-slot frequency hopping by applying a same offset to both a first physical resource block (PRB) of the resources and to a second hop PRB.

Aspect 33. The method of Aspect 31, wherein determining whether to transmit the physical uplink channel with inter-slot frequency hopping comprises adapting the resources for inter-slot frequency hopping by applying a first offset to a starting PRB of the resources and applying a second offset to a second hop PRB.

Aspect 34. The method of Aspect 31, wherein the UE is configured with a starting PRB and second hop PRB specific to the SBFD symbols, and wherein inter-slot frequency hopping is enabled.

Aspect 35. The method of Aspect 31, wherein the UE is configured with a list of starting PRB, second hop PRB, and number of resource blocks, the list including at least a first set of values applicable to the non-SBFD symbols and a second set of values applicable to the SBFD symbols.

Aspect 36. The method of Aspect 31, wherein the physical uplink channel is scheduled or activated by a downlink control information (DCI) that indicates a selected second hop PRB for the physical uplink channel.

Aspect 37. The method of any of Aspects 31-36, wherein the resources on the slot configured with SBFD symbols are configured with a start symbol and a number of symbols specific to the SBFD symbols.

Aspect 38. A method of wireless communications at a base station comprising: transmitting, to a user equipment (UE), a configuration of a physical uplink channel, the configuration being applicable to sub-band full duplex (SBFD) symbols and to non-SBFD symbols; transmitting an indication of resources for transmission on at least a slot configured with the SBFD symbols; and determining whether the UE transmits the physical uplink channel on the resources based on whether all resource blocks of the physical uplink channel are within an uplink sub-band.

Aspect 39. The method of Aspect 38, wherein all resource blocks of the physical uplink channel are not within the uplink sub-band, further comprising dropping the physical uplink channel.

Aspect 40. The method of Aspect 38, wherein all resource blocks of the physical uplink channel are not within the uplink sub-band, further comprising adapting the resources to accommodate all resource blocks of the physical uplink channel within the uplink sub-band.

Aspect 41. The method of Aspect 40, wherein adapting the resources comprises adjusting a starting physical resource block (PRB) of the resources by an offset that is configured or derived by the base station.

Aspect 42. The method of Aspect 40 or 41, wherein adapting the resources comprises selecting a starting resource block and a number of resource blocks for the resources from a list of resources for non-SBFD symbols and for SBFD symbols.

Aspect 43. The method of Aspect 42, wherein adapting the resources comprises adjusting a number of symbols based on the number of resource blocks to maintain a same size of the resources.

Aspect 44. The method of Aspect 42 or 43, wherein adapting the resources compromises adjusting time domain resources for the number of resource blocks to maintain a maximum coding rate of the physical uplink channel specific to the SBFD symbols.

Aspect 45. The method of Aspect 40, wherein the resources on the slot configured with SBFD symbols are configured with a starting resource block and a number of resource blocks specific to the SBFD symbols.

Aspect 46. The method of Aspect 45, wherein the resources on the slot configured with SBFD symbols are configured with a start symbol and a number of symbols specific to the SBFD symbols.

Aspect 47. The method of Aspect 38, wherein the resources on the slot configured with SBFD symbols are configured with a starting resource block applicable to both non-SBFD symbols and SBFD symbols, a starting resource block specific to the SBFD symbols, or both.

Aspect 48. The method of Aspect 47, wherein the resources on the slot configured with SBFD symbols are configured with a number of resource blocks applicable to both non-SBFD symbols and SBFD symbols, a number of resource blocks specific to the SBFD symbols, or both.

Aspect 49. The method of any of Aspects 38-48, further comprising determining whether to receive the physical uplink channel with intra-slot frequency hopping.

Aspect 50. The method of Aspect 49, wherein determining whether to receive the physical uplink channel with intra-slot frequency hopping comprises disabling intra-slot frequency hopping on the SBFD symbols.

Aspect 51. The method of Aspect 49, wherein determining whether to receive the physical uplink channel with intra-slot frequency hopping comprises disabling intra-slot frequency hopping on the SBFD symbols when at least one physical resource block of a set of configured second hop physical resource blocks is outside of the uplink sub-band.

Aspect 52. The method of Aspect 49, wherein determining whether to receive the physical uplink channel with intra-slot frequency hopping comprises adapting the resources for intra-slot frequency hopping by applying a same offset to both a starting physical resource block (PRB) of the resources and to a second hop PRB.

Aspect 53. The method of Aspect 49, wherein determining whether to receive the physical uplink channel with intra-slot frequency hopping comprises adapting the resources for intra-slot frequency hopping by applying a first offset to a starting PRB of the resources and applying a second offset to a second hop PRB.

Aspect 54. The method of Aspect 49, wherein the UE is configured with a starting PRB and second hop PRB specific to the SBFD symbols, and wherein intra-slot frequency hopping is enabled.

Aspect 55. The method of Aspect 54, wherein the UE is configured with a number of resource blocks specific to the SBFD symbols.

Aspect 56. The method of Aspect 54, wherein the UE is configured with a list of starting PRB, second hop PRB, and number of resource blocks, the list including at least a first set of values applicable to the non-SBFD symbols and a second set of values applicable to the SBFD symbols.

Aspect 57. The method of Aspect 49, wherein the physical uplink channel is scheduled or activated by a downlink control information (DCI) that indicates a selected second hop PRB for the physical uplink channel.

Aspect 58. The method of any of Aspects 38-57, further comprising determining whether to receive the physical uplink channel on the slot configured with the SBFD symbols with a configured or indicated number of repetitions based on whether the slot configured with the SBFD symbols is considered an available slot for repetition.

Aspect 59. The method of Aspect 58, wherein the slot configured with the SBFD symbols is considered an available slot for a repetition of the physical uplink channel.

Aspect 60. The method of Aspect 58, further comprising dropping the repetition of the physical uplink channel if any resource blocks of the repetition are outside of the uplink sub-band.

Aspect 61. The method of Aspect 58, further comprising adapting the resources to accommodate all resource blocks of the repetition within the uplink sub-band.

Aspect 62. The method of Aspect 58, wherein the slot configured with the SBFD symbols is considered an available slot for a repetition of the physical uplink channel when the SBFD symbols accommodate all resource blocks of the repetition within the uplink sub-band in both time and frequency domains.

Aspect 63. The method of Aspect 62, wherein the SBFD symbols accommodate all resource blocks of the repetition based on a starting resource block applicable to both non-SBFD symbols and SBFD symbols, a starting resource block specific to the SBFD symbols, or both and a number of resource blocks applicable to both non-SBFD symbols and SBFD symbols, a number of resource blocks specific to the SBFD symbols, or both.

Aspect 64. The method of Aspect 62, wherein the SBFD symbols accommodate all resource blocks of the repetition based on a PRB configuration specific to the SBFD symbols.

Aspect 65. The method of Aspect 58, wherein the slot configured with the SBFD symbols is considered an available slot for repetition when a first slot for transmission of the physical uplink channel is a slot configured with the SBFD symbols.

Aspect 66. The method of any of Aspects 38-65, further comprising determining whether to receive the physical uplink channel on one or more slots configured with the SBFD symbols with a configured or indicated number of repetitions and inter-slot frequency hopping.

Aspect 67. The method of Aspect 66, wherein inter-slot frequency hopping is disabled on the SBFD symbols.

Aspect 68. The method of Aspect 66, further comprising adjusting a first PRB of the resources in the slot configured with the SBFD symbols for reception of the physical uplink channel with inter-slot frequency hopping.

Aspect 69. The method of Aspect 68, wherein determining whether to receive the physical uplink channel with inter-slot frequency hopping comprises adapting the resources for inter-slot frequency hopping by applying a same offset to both the first PRB of the resources and to a second hop PRB.

Aspect 70. The method of Aspect 68, wherein determining whether receive the physical uplink channel with inter-slot frequency hopping comprises adapting the resources for inter-slot frequency hopping by applying a first offset to a starting PRB of the resources and applying a second offset to a second hop PRB.

Aspect 71. The method of Aspect 68, wherein the UE is configured with a starting PRB and second hop PRB specific to the SBFD symbols, and wherein inter-slot frequency hopping is enabled.

Aspect 72. The method of Aspect 68, wherein the UE is configured with a list of starting PRB, second hop PRB, and number of resource blocks, the list including at least a first set of values applicable to the non-SBFD symbols and a second set of values applicable to the SBFD symbols.

Aspect 73. The method of Aspect 68, wherein the physical uplink channel is scheduled or activated by a downlink control information (DCI) that indicates a selected second hop PRB for the physical uplink channel.

Aspect 74. The method of any of Aspects 68-73, wherein the resources on the slot configured with SBFD symbols are configured with a start symbol and a number of symbols specific to the SBFD symbols.

Aspect 75. An apparatus for wireless communication, comprising: a transceiver; a memory storing computer-executable instructions; and a processor coupled with the transceiver and the memory and configured to: execute the computer-executable instructions to execute the instructions to perform the method of any of Aspects 1-37.

Aspect 76. An apparatus for wireless communication, comprising: a transceiver; a memory storing computer-executable instructions; and a processor coupled with the transceiver and the memory and configured to execute the computer-executable instructions to perform the method of any of Aspects 38-74.

Aspect 77. An apparatus for wireless communication, comprising means for performing the method of any of Aspects 1-37.

Aspect 78. An apparatus for wireless communication, comprising means for performing the method of any of Aspects 38-74.

Aspect 79. A non-transitory computer-readable medium storing computer-executable instructions that when executed by a processor of a user equipment (UE) cause the UE to perform the method of any of Aspects 1-37.

Aspect 80. A non-transitory computer-readable medium storing computer-executable instructions that when executed by a processor of a network entity cause the network entity to perform the method of any of Aspects 38-74.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communications at a user equipment (UE), comprising:
receiving a configuration of a physical uplink channel, the configuration being applicable to sub-band full duplex (SBFD) symbols and to non-SBFD symbols;
receiving an indication of resources for transmission on at least a slot configured with the SBFD symbols; and
determining whether to transmit the physical uplink channel on the resources based on whether all resource blocks of the physical uplink channel are within an uplink sub-band.

2. The method of claim 1, wherein all resource blocks of the physical uplink channel are not within the uplink sub-band, further comprising dropping the physical uplink channel.

3. The method of claim 1, wherein the resources on the slot configured with SBFD symbols are configured with a starting resource block and a number of resource blocks specific to the SBFD symbols.

4. The method of claim 3, wherein the resources on the slot configured with SBFD symbols are configured with a start symbol and a number of symbols specific to the SBFD symbols.

5. The method of claim 1, wherein the resources on the slot configured with SBFD symbols are configured with a starting resource block applicable to both non-SBFD symbols and SBFD symbols, a starting resource block specific to the SBFD symbols, or both.

6. The method of claim 5, wherein the resources on the slot configured with SBFD symbols are configured with a number of resource blocks applicable to both non-SBFD symbols and SBFD symbols, a number of resource blocks specific to the SBFD symbols, or both.

7. The method of claim 1, further comprising determining whether to transmit the physical uplink channel with intra-slot frequency hopping.

8. The method of claim 7, wherein determining whether to transmit the physical uplink channel with intra-slot frequency hopping comprises one of:
disabling intra-slot frequency hopping on the SBFD symbols;
disabling intra-slot frequency hopping on the SBFD symbols when at least one physical resource block of a set of configured second hop physical resource blocks is outside of the uplink sub-band;
adapting the resources for intra-slot frequency hopping by applying a same offset to both a starting physical resource block (PRB) of the resources and to a second hop PRB; or
adapting the resources for intra-slot frequency hopping by applying a first offset to a starting PRB of the resources and applying a second offset to a second hop PRB.

9. The method of claim 7, wherein the UE is configured with a starting PRB and second hop PRB specific to the SBFD symbols, and wherein intra-slot frequency hopping is enabled.

10. The method of claim 7, wherein the physical uplink channel is scheduled or activated by a downlink control information (DCI) that indicates a selected second hop PRB for the physical uplink channel.

11. The method of claim 1, further comprising determining whether to transmit the physical uplink channel on the slot configured with the SBFD symbols with a configured or indicated number of repetitions based on whether the slot configured with the SBFD symbols is considered an available slot for repetition.

12. The method of claim 11, wherein the slot configured with the SBFD symbols is considered an available slot for a repetition of the physical uplink channel, the method further comprising dropping the repetition of the physical uplink channel if any resource blocks of the repetition are outside of the uplink sub-band.

13. The method of claim 11, further comprising adapting the resources to accommodate all resource blocks of the repetition within the uplink sub-band.

14. The method of claim 11, wherein the slot configured with the SBFD symbols is considered an available slot for a repetition of the physical uplink channel when the SBFD symbols accommodate all resource blocks of the repetition within the uplink sub-band in both time and frequency domains.

15. The method of claim 11, wherein the slot configured with the SBFD symbols is considered an available slot for repetition when a first slot for transmission of the physical uplink channel is a slot configured with the SBFD symbols.

16. The method of claim 1, further comprising determining whether to transmit the physical uplink channel on one or more slots configured with the SBFD symbols with a configured or indicated number of repetitions and inter-slot frequency hopping.

17. The method of claim 16, further comprising adjusting a first PRB of the resources in the slot configured with the SBFD symbols for transmission of the physical uplink channel with inter-slot frequency hopping.

18. The method of claim 17, wherein determining whether to transmit the physical uplink channel with inter-slot frequency hopping comprises one of:
adapting the resources for inter-slot frequency hopping by applying a same offset to both a first physical resource block (PRB) of the resources and to a second hop PRB; or
adapting the resources for inter-slot frequency hopping by applying a first offset to a starting PRB of the resources and applying a second offset to a second hop PRB.

19. The method of claim 17, wherein the UE is configured with a starting PRB and second hop PRB specific to the SBFD symbols, and wherein inter-slot frequency hopping is enabled.

20. The method of claim 17, wherein the UE is configured with a list of starting PRB, second hop PRB, and number of resource blocks, the list including at least a first set of values applicable to the non-SBFD symbols and a second set of values applicable to the SBFD symbols.

21. The method of claim 17, wherein the physical uplink channel is scheduled or activated by a downlink control information (DCI) that indicates a selected second hop PRB for the physical uplink channel.

22. A method of wireless communications at a base station comprising:
transmitting, to a user equipment (UE), a configuration of a physical uplink channel, the configuration being applicable to sub-band full duplex (SBFD) symbols and to non-SBFD symbols;
transmitting an indication of resources for transmission on at least a slot configured with the SBFD symbols; and
determining whether the UE transmits the physical uplink channel on the resources based on whether all resource blocks of the physical uplink channel are within an uplink sub-band.

23. The method of claim 22, wherein all resource blocks of the physical uplink channel are not within the uplink sub-band, further comprising dropping the physical uplink channel.

24. The method of claim 22, wherein the resources on the slot configured with SBFD symbols are configured with a starting resource block applicable to both non-SBFD symbols and SBFD symbols, a starting resource block specific to the SBFD symbols, or both.

25. The method of claim 24, wherein the resources on the slot configured with SBFD symbols are configured with a number of resource blocks applicable to both non-SBFD symbols and SBFD symbols, a number of resource blocks specific to the SBFD symbols, or both.

26. The method of claim 22, further comprising determining whether to receive the physical uplink channel with intra-slot frequency hopping.

27. The method of claim 22, further comprising determining whether to receive the physical uplink channel on the slot configured with the SBFD symbols with a configured or indicated number of repetitions based on whether the slot configured with the SBFD symbols is considered an available slot for repetition.

28. The method of claim 22, further comprising determining whether to receive the physical uplink channel on one or more slots configured with the SBFD symbols with a configured or indicated number of repetitions and inter-slot frequency hopping.

29. An apparatus for wireless communication at a user equipment, comprising:
one or more memories, individually or in combination, storing computer-executable instructions; and
a processor coupled with the one or more memories and, individually or in combination, configured to:
receive a configuration of a physical uplink channel, the configuration being applicable to sub-band full duplex (SBFD) symbols and to non-SBFD symbols;
receive an indication of resources for transmission on at least a slot configured with the SBFD symbols; and
determine whether to transmit the physical uplink channel on the resources based on whether all resource blocks of the physical uplink channel are within an uplink sub-band.

30. An apparatus for wireless communication at a network entity, comprising:
one or more memories, individually or in combination, storing computer-executable instructions; and
a processor coupled with the one or more memories and, individually or in combination, configured to:
transmit, to a user equipment (UE), a configuration of a physical uplink channel, the configuration being applicable to sub-band full duplex (SBFD) symbols and to non-SBFD symbols;
transmit an indication of resources for transmission on at least a slot configured with the SBFD symbols; and
determine whether the UE transmits the physical uplink channel on the resources based on whether all resource blocks of the physical uplink channel are within an uplink sub-band.
